(19) United States
(12) Patent Application Publication
(10) Pub. No.: US 2020/0089691 A1
(43) Pub. Date: Mar. 19, 2020

(54) SYSTEM AND METHOD FOR REGULARIZING DATA BETWEEN DATA SOURCE AND DATA DESTINATION

(71) Applicant: Innoplexus AG, Eschborn (DE)

(72) Inventors: Ankur Zilpelwar, Pusad (IN); Dileep Dharma, Pune (IN); Jaimin Mehta, Pune (IN); Prashant Patil, Pune (IN); Abhilash Bolla, Vadodara (IN); Hitesh Chavhan, Thane (IN); Rohit Anurag, Bokaro (IN)

(21) Appl. No.: 16/366,567

(22) Filed: Mar. 27, 2019

(30) Foreign Application Priority Data
Jun. 30, 2018 (GB) 1810802.7

(51) Int. Cl. G06F 16/28; G06F 16/25; G06F 16/22; G06F 16/21

(52) U.S. Cl. CPC G06F 16/285; G06F 16/258; G06F 16/95; G06F 16/211; G06F 16/2282

(57) ABSTRACT

A system and method of regularizing data between a data source and a data destination, wherein the given data category includes with specific data fields. The system includes a data processing arrangement that includes a data fetching module operable to fetch data from the data source. Furthermore, the data processing arrangement includes a data transformation module that is operable to receive pre-defined data formats for a specific data category, compare data formats of the fetched data with pre-defined data formats, determine a deviation therein, and thereafter transform the data format. Additionally, the data processing arrangement includes a data validation module operable that is to receive the transformed data or the fetched data, confirm if data formats of a received data are same as corresponding pre-defined data formats, identify from the received data regularized data, and transmit the regularized data to the data destination implemented as database arrangement.

### CROSS-REFERENCE TO RELATED APPLICATIONS

This application claims the benefit under 35 U.S.C. § 119(a) and 37 CFR § 1.55 to UK Patent Application No. GB1810802.7, filed on Jun. 30, 2018, the entire content of which is incorporated herein by reference.

### TECHNICAL FIELD

The present disclosure relates generally to data processing; and more specifically, to systems for regularizing data between a data source and a data destination. Furthermore, the present disclosure relates to methods of (for) regularizing data between a data source and a data destination. Moreover, the present disclosure also relates to computer readable medium containing program instructions for execution on a computer system, which when executed by a computer, cause the computer to perform method steps of regularizing data between a data source and a data destination.

### BACKGROUND

In recent years, there has been an explosion of information on the World Wide Web. Currently, the information in the World Wide Web is recorded and stored in form of electronic documents for convenient storing of bulk data and effective access and use of the stored bulk data. Furthermore, with the technological development information is shared over the World Wide Web to be saved at any remote location. For example, data and information related to different patients suffering from a disease and admitted in a hospital can be stored in form of electronic documents at remote locations.

Typically, the electronic document storing the data and information comprise of various fields which helps in categorizing the data and information. Presently, the different electronic documents relating to a common domain generally include different formats for storing the data and information with the fields.

However, these conventional electronic documents storing the data and information have multiple technical problems. One of such technical problem is that, the electronic documents are configured to store data and information in different formats. Therefore, the lack of a standardized format often makes the use of such stored data and information cumbersome. Another technical problem associated with the use of the conventional electronic documents is loss of computation time. For example, often the data and information may be analysed by a specific tool which needs to convert the format of the data and information into a specific format as per the preference of the specific tool. Such process requires additional processing time and thereby creating loss of computation time for the overall analysis process performed by the specific tool. Furthermore, the conversion of the formats may not be appropriate every time. Thus, the analysis process performed by the specific tool on the data and information converted into the specific format may generate frivolous output.

Therefore, in light of the foregoing discussion, there exists a need to overcome the aforementioned drawbacks by associated with the data format in which the data and information is stored.

### SUMMARY

The present disclosure seeks to provide a system for regularizing data between a data source and a data destination, the data corresponding to a given data category of a plurality of data categories, wherein the given data category includes specific data fields. The present disclosure also seeks to provide a method for (of) regularizing data between a data source and a data destination, the data corresponding to a given data category of a plurality of data categories, wherein the given data category includes with specific data fields. The present disclosure also seeks to provide a computer readable medium containing program instruction for execution on a computer system, which when executed by a computer, causes the computer to perform method steps for regularizing data between a data source and a data destination. The present disclosure seeks to provide at least a solution to the existing problem associated with the data format in which the data and information is stored. An aim of the present disclosure is to provide a solution that overcomes at least a problem encountered in prior art, and provides a standardise and efficient system for regularizing data between a data source and a data destination, and storing the regularizing data therein. Moreover, the present disclosure provides an optimal system for substantially reducing manual intervention required in regularizing data between a data source and a data destination into a standardise format and storing therein.

In one aspect, an embodiment of the present disclosure provides a system for regularizing data between a data source and a data destination, the data corresponding to a given data category of a plurality of data categories, wherein the given data category includes specific data fields, wherein the system comprises:

a data processing arrangement comprising:

a data fetching module operable to fetch data from the data source, wherein the fetched data includes one or more data fields having values in corresponding data formats;

a data transformation module operable to receive the fetched data from the data fetching module, wherein the data transformation module is operable to:

receive pre-defined data formats for the values of data fields for a specific data category;

compare data formats of values of data fields of the fetched data with received pre-defined data formats for the values;

determine, based on the comparison, a deviation between a data format of at least one value and a corresponding pre-defined data format for the at least one value; and

transform the data format of the at least one value to the corresponding pre-defined data format, if the deviation is determined;

a data validation module operable to:

receive from the data transformation module, the pre-defined data formats, and the transformed data if the deviation is determined, or the fetched data if the deviation is not determined;

confirm if data formats of values of all data fields of a received data are same as corresponding pre-defined data formats;

identify from the received data, based on the confirmation, regularized data having data formats of values of all data fields same as the corresponding pre-defined data formats;

transmit the regularized data to the data destination;

and
a database arrangement for implementing the data destination, the database arrangement being communicatively coupled to the data processing arrangement, wherein the database arrangement is operable to store the received regularized data.

In another aspect, an embodiment of the present disclosure provides a method for regularizing data between a data source and a data destination, the data corresponding to a given data category of a plurality of data categories, wherein the given data category includes with specific data fields, wherein the method comprises:

fetching from the data source, a data including one or more data fields having values in corresponding data formats;

receiving pre-defined data formats for the values of data fields for a specific data category;

comparing data formats of values of data fields of the fetched data with pre-defined data formats for the values;

determining, based on the comparison, a deviation between a data format of at least one value and a corresponding pre-defined data format for the at least one value;

transforming the data format of the at least one value to the corresponding pre-defined data format, if the deviation is determined;

confirming if data formats of values of all data fields of a received data are same as corresponding pre-defined data formats;

identifying from the received data, based on the confirmation, regularized data having data formats of values of all data fields same as the corresponding pre-defined data formats; and

storing the regularized data at the data destination.

In yet another aspect, the present disclosure provides a computer readable medium containing program instruction for execution on a computer system, which when executed by a computer, cause the computer to perform method steps for regularizing data between a data source and a data destination, the data corresponding to a given data category of a plurality of data categories, wherein the given data category includes with specific data fields, the method comprising the steps of:

fetching from the data source, a data including one or more data fields having values in corresponding data formats;

receiving pre-defined data formats for the values of data fields for a specific data category;

comparing data formats of values of data fields of the fetched data with pre-defined data formats for the values;

determining, based on the comparison, a deviation between a data format of at least one value and a corresponding pre-defined data format for the at least one value;

transforming the data format of the at least one value to the corresponding pre-defined data format, if the deviation is determined;

confirming if data formats of values of all data fields of a received data are same as corresponding pre-defined data formats;

identifying from the received data, based on the confirmation, regularized data having data formats of values of all data fields same as the corresponding pre-defined data formats; and

storing the regularized data at the data destination.

Embodiments of the present disclosure substantially eliminate or at least address the aforementioned problems in the prior art, and enables regularized data storage with substantially reduced human intervention.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is an illustration of a block diagram of a system for regularizing data between a data source and a data destination, in accordance with an embodiment of the present disclosure; and

FIG. 2 is an illustration of steps of a method for (of) regularizing data between a data source and a data destination, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

In overview, embodiments of the present disclosure are concerned with system for regularizing data between a data source and a data destination, the data corresponding to a given data category of a plurality of data categories, wherein the given data category includes specific data fields. The embodiments are concerned with an improved technical manner of regularizing data between a data source and a data destination, wherein more efficient data processing is enabled that can reduce the overall computation time of the system and the erroneousness of the system, and thereby potentially reduce energy dissipation in the system and improve their temporal responsiveness when in operation.

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides a system for regularizing data between a data source and a data destination, the data corresponding to a given data category of a plurality of data categories, wherein the given data category includes specific data fields, wherein the system comprises:

a data processing arrangement comprising:

a data fetching module operable to fetch data from the data source, wherein the fetched data includes one or more data fields having values in corresponding data formats;

a data transformation module operable to receive the fetched data from the data fetching module, wherein the data transformation module is operable to:

receive pre-defined data formats for the values of data fields for a specific data category;

compare data formats of values of data fields of the fetched data with received pre-defined data formats for the values;

determine, based on the comparison, a deviation between a data format of at least one value and a corresponding pre-defined data format for the at least one value; and

transform the data format of the at least one value to the corresponding pre-defined data format, if the deviation is determined;

a data validation module operable to:

receive from the data transformation module, the pre-defined data formats, and the transformed data if the deviation is determined, or the fetched data if the deviation is not determined;

confirm if data formats of values of all data fields of a received data are same as corresponding pre-defined data formats;

identify from the received data, based on the confirmation, regularized data having data formats of values of all data fields same as the corresponding pre-defined data formats;

transmit the regularized data to the data destination;

and
a database arrangement for implementing the data destination, the database arrangement being communicatively coupled to the data processing arrangement, wherein the database arrangement is operable to store the received regularized data.

In another aspect, an embodiment of the present disclosure provides a method for regularizing data between a data source and a data destination, the data corresponding to a given data category of a plurality of data categories, wherein the given data category includes with specific data fields, wherein the method comprises:

fetching from the data source, a data including one or more data fields having values in corresponding data formats;

receiving pre-defined data formats for the values of data fields for a specific data category;

comparing data formats of values of data fields of the fetched data with pre-defined data formats for the values;

determining, based on the comparison, a deviation between a data format of at least one value and a corresponding pre-defined data format for the at least one value;

transforming the data format of the at least one value to the corresponding pre-defined data format, if the deviation is determined;

confirming if data formats of values of all data fields of a received data are same as corresponding pre-defined data formats;

identifying from the received data, based on the confirmation, regularized data having data formats of values of all data fields same as the corresponding pre-defined data formats; and

storing the regularized data at the data destination.

The present disclosure provides a system and a method for regularizing data between the data source and the data destination. The plurality of modules (namely, the data fetching module, the data transformation module, data validation module, and the data regularization module) hosted by the data processing arrangement is operable standardize and normalize the data acquired from the data source. Furthermore, the transformation module includes pre-defined data formats based on which the fetch data from the data source is regularized. Therefore, all the data transformed by the transformation module regularizes into a single standardized format. Moreover, the data transformed by the transformation module is validated by the data validation module. Therefore, the data validation module ensures that the transformed data is appropriate to be stored in the data destination. Additionally, the data regularization module is configured to resolve variance determine in the data provided by the data validation module. Beneficially, such architecture ensures the system to include an improved efficiency for regularizing data between the data source and the data destination. Additionally, the plurality of modules hosted by the data processing arrangement is implemented using a machine-learning algorithm. Beneficially, the machine-learning algorithm enables the system to reduce data processing time and increase reliability efficiency of the system. Furthermore, the implementation of the plurality of modules using a machine-learning algorithm enables the system to be efficient and reliable.

The system regularizes data between the data source and the data destination. The system refers to a collection of one or more programmable and non-programmable components that are operable to aggregate, standardize, and normalize data. In an example, the system may be a framework that is operable to perform end-to-end automation of data processing, validation and error logging for the data. Throughout the present disclosure, the term “data” relates to information obtained from any source that can be processed and stored on a computer readable media. In an example, the data can be information including text in an electronic document related to a specific domain such as pharmaceuticals. In another example, the data can be sensory information acquired from a medical device having sensors. Optionally, data is operable to include attribute, characteristic, property, number, quantity and the like of a specific domain and/or environment.

Throughout the present disclosure, the term “data source” relates to a repository where the data is stored in a digital form that can be used for further computational process. Optionally, the data source can be implemented using as at least one database. Throughout the invention, the term “database” as used herein relates to an organized body of digital information regardless of the manner in which the data or the organized body thereof is represented. Optionally, the database may be hardware, software, firmware and/or any combination thereof. For example, the organized body of related data may be in the form of a table, a map, a grid, a packet, a datagram, a file, a document, a list or in any other form. The database includes any data storage software and systems, such as, for example, a relational database like IBM DB2 and Oracle 9. Optionally, the database may be used interchangeably herein as database management system, as is common in the art. In an example, the data source may be a database of patent documents of specific domain such as pharmaceuticals.

Optionally, the data source can be implemented as a structured data wherein the data resides in an organized form. In another example, the data source may be a spreadsheet that stores structured data related to sensory information acquired from medical devices coupled to one or more patient. Optionally, the data source can be an integral part of the system. Specifically, the system can include a data storage that operates as a data source. For example, the data source can be a database within the system that stores relevant data in a digital form for further computational process. It will be appreciated that the relevant data refers to information related to specific domain stored in digital form. Optionally, the data source can be implemented as a local database within the system. Optionally, the data source can be implemented as a third-party database in which data is fetched by the system from the third-party database. The third-party database refers to one or more systems, applications, and/or a combination thereof for providing electronic content (namely, information related to specific domain stored in digital form) to the system via a data network. Furthermore, the third-party database is subscription based, i.e. the information related to specific domain is provided as an online service that is accessed by the system with subscriber accounts.

Furthermore, regularizing data relates to a process of producing a standard data structure from various standard data and non-standard data at single or multiple data sources. Optionally, the standard data can include a specific format and/or specific fields for storing the data fetched from the data source. Furthermore, regularizing data refers to arranging the data fetched form the data source in the specific format and/or specific fields of the standard data structure. In an example, the data at the data source can have a format comprising fields like a title, a description, an abstract and a conclusion in the stated order while the standard format requires the data in a format comprising fields like the title, the abstract, the description and the conclusion in the stated order, in this case regularization of data allows making the order of data at the data source similar to the order of standard data. In another example, the data at the data source can have the format comprising date in the format year-month-date, another data at another data source can have date in the format month-year-date, yet another data at yet another data source can have date in the format date-year-month while the standard format requires the date in the format date-year-month, in this case regularization of data allows making the format of date at the data source similar to the format of date of the standard format.

Furthermore, the system is operable to store the regularized data into the data destination. Throughout the present disclosure, the term “data destination” relates to a data storage for digital media wherein the data upon being regularized by the system is stored in a format that can be used for further computation processing. Optionally, the data destination includes a volatile or persistent medium, such as an electrical circuit, magnetic disk, virtual memory or optical disk, in which the regularized data can be stored for any duration. Optionally, the data destination is a non-volatile mass storage such as physical storage media that can be distributed in a scenario wherein system is implemented in a distributed architecture.

The data corresponds to a given data category of a plurality of data categories. The term ‘category’ refers to a type of digital data and/or content. Specifically, category refer to the type of file format of plurality of digital content that has a specific format, such as patents, research papers, sales report, business plans, medical reports and the likes. Optionally, the data category corresponds to a discipline or a sector to which the data is stored in a specific format. Furthermore, each data category of the plurality of data categories can include documents, files, scripts, codes, executable programs, web pages or any other digital data that can be transmitted via a network (such as the Internet). Furthermore, data corresponding to the given data category and other data corresponding to other data categories can be regularized all at the same moment consequently. Optionally, the plurality of data categories corresponds to the various other disciplines or sectors that the other data is related to.

Furthermore, the given data category includes specific data fields. The term ‘data field’ relates to a section in data format of the data category that is operable to store specific parts of the information described in the data. In an example, a data category may be patents of pharmaceuticals, may include data fields such as title, background, summary, abstract and the like, within which information related to the patent may be segregated. In another example, a data category may be scientific articles of electronics, may include data fields such as name of the author, abstract, date of publishing of the article and the like, within which information related to the scientific article may be segregated. In yet another example, a data category may be business plan including data fields like name of company, contact information, a table of content, a problem being solved, a target market, and a revenue model. Optionally, the data field are operable to segregate the information described in the data based on attributes of content of the data.

Furthermore, the system comprises a data processing arrangement. Throughout the present disclosure, the term “data processing arrangement” relates to an arrangement of hardware components that is employed for processing data associated with an input, to generate an output. The arrangement of hardware components forming the data processing arrangement can include, for example, a central processing unit (CPU), a random-access memory (RAM), a graphics processing unit (GPU) and so forth. Furthermore, the CPU is operable to execute an instruction set to obtain the output (such as the extracted tabular data) from the input (such as the electronic document) provided to the data processing arrangement. Moreover, the RAM, the GPU and other hardware components associated with the data processing arrangement are operable to synergistically operate with the CPU, to enable the CPU to generate the output from the input.

The CPU of the data processing arrangement can be implemented to have various configurations, for example, as a microprocessor comprising one or more processor cores therein. In such an example, the data processing arrangement can have a dual-core configuration, a quad-core configuration, a hexa-core configuration, an octa-core configuration, a deca-core configuration and so forth. Furthermore, a preference of the configuration of the data processing arrangement depends on requirements of the process, such as, a performance efficiency, a power consumption, and/or a time required for generating the output from the input. Furthermore, it will be appreciated that the data processing arrangement having the microprocessor therein (and thus, the system) can be implemented in a device including, but not limited to, a laptop computer, a tablet computer, a smartphone, a personal digital assistant (PDA) and so forth.

Optionally, the data processing arrangement is implemented within a server arrangement. Throughout the present disclosure, the term “server arrangement” relates to an arrangement including programmable and/or non-programmable components configured to regularize data between the data source and the data destination. Optionally, the server arrangement includes any arrangement of physical or virtual computational entities capable of enhancing information to perform various computational tasks. For example, the data between the data source and the data destination that is regularized may operate as slandered data to be accessed by interested parties for research and/or commercialization purposes. It will be appreciated that the interested parties refer to any entity including a person (i.e., human being) or a virtual personal assistant (an autonomous program or a bot) using a device and/or system described herein. Furthermore, it should be appreciated that the server may be both single hardware server and/or plurality of hardware servers operating in a parallel or distributed architecture. In an example, the server arrangement may include components such as memory, a processor, a network adapter and the like, to store, process and/or share information with other computing components, such as user device/user equipment. Optionally, the server arrangement is implemented as a computer program that provides various services (such as database service) to other devices, modules or apparatus. Optionally, the server-arrangement including a single server or multiple servers can be communicably coupled with each other. Optionally, the server-arrangement is a server deployed in a cloud environment which is connected to the remote servers. Optionally, the server-arrangement is implemented as two or more servers operating in a parallel and/or in a distributed architecture. Optionally, the data processing arrangement implemented within a server arrangement is configured to host one or more software modules therein, for performing the specific action of regularizing data between a data source and a data destination.

The data processing arrangement comprises data fetching module operable to fetch data from the data source. Throughout the present disclosure, the term “data fetching module” relates to a collection or a set of routines responsible for executing an instruction or a sub-set of instructions from the instruction set that is executed by the data processing arrangement, to generate a specific output from an input. Specifically, the set of routines of the data fetching module executing an instruction or a sub-set of instructions is operable to extract data from the data source. In an example, the set of routines executing an instruction or a sub-set of instructions may be operable to instruct one or more components of the server arrangement implementing the data processing arrangement to extract data from the data source. Optionally, the data fetching module can fetch the data from the data source by connections like wireless connection, wired connection or a combination of wired and wireless connection. Examples of the connections can include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, radio networks, telecommunication networks, and

Worldwide Interoperability for Microwave Access (WiMAX) networks.

The fetched data includes one or more data fields having values in corresponding data formats. Specifically, the data fetched from the data source includes one or more data fields having values in corresponding data formats. Furthermore, the values associated to the one or more data fields refer to the specific type of content included therein. Moreover, the specific type of content is included in the one or more data fields are values of the corresponding data fields. Furthermore, the specific type of content included in the one or more data fields includes specific data format therein. In an example, data field, namely abstract, in a category, namely patent, may include values, namely text which will correspond to a brief overview of the patent, wherein the text will be in a format wherein the word count is less than 150 words. In another example, data field, namely title, in a category, namely patent, may include values, namely text which will correspond to an appropriate heading of the patent, wherein the text will be in a format wherein the word count is less than 250 characters. In another example, data field may be date in a category, namely patent may include values, namely number which will correspond to date of filling of the patent, wherein the date is in the format date-month-year.

Optionally, the data fetching module is implemented using a machine-learning algorithm. The machine-learning algorithm can be trained to fetch the data from the data source on the basis of fetching of data from the data source initially by a manual input. The machine-learning algorithm can be used by the fetching module to fetch the data from the data source by connections like wireless connection, wired connection or a combination of wired and wireless connection. Furthermore, the machine-learning algorithm can comprise networks (such as, artificial neural networks (ANN), recurrent neural network (RNN), convolutional neural network (CNN) and so forth) for fetching data from the data source. Optionally, the machine-learning algorithm can have pre-defined instructions for directly fetching the data, the instructions comprising various parameters like steps for fetching, location of data in the data source. Optionally, the machine-learning algorithm along with manual inputs can be implemented together on data fetching module for fetching the data from the data source. Optionally, the machine-learning algorithm can be operable to reduce fetching time while acquiring the data from the data source.

Optionally, the data fetching module is implemented as a web-crawler. Optionally, the fetching of the data is performed by the web crawler. The web crawlers can also be referred to as ants, bots, automatic indexers, web spiders, web robots, web scutters, and the like. The web-crawler can be configured to crawl and/or fetch data from the data source over a network, such as intranet or internet, in a methodical and orderly way. Optionally, the crawler contains a number of rules for interpreting information found at the data source. These rules enable the web crawler to acquire relevant information from the data source as an amount of information available on the data source continues to grow exponentially and only a portion of the information may be relevant. Optionally, the rules enable fetching the data available at the data source related to the subject-matter (such as pharmaceuticals).

The data processing arrangement comprising the data transformation module is operable to receive the fetched data from the data fetching module. Throughout the present disclosure, data transformation module relates to a combination of hardware and/or software instructions which are operable for transforming data from the data source. Optionally, the data transformation module is a collection or a set of routines responsible for executing an instruction or a sub-set of instructions from the instruction set that is executed by the data processing arrangement, to generate a specific output from an input. Specifically, the set of routines of the data transformation module executing an instruction or a sub-set of instructions is operable to transform data that is fetched from the data source. Furthermore, the set of routines of the data transformation module is operable to acquire the data fetched by the data fetching module. Alternatively, in an environment wherein the data processing arrangement is implemented is a distributed environment, the data transformation module operable to receive the fetched data from the data fetching module can be connected via various connection, such as wireless connection, wired connection or a combination of wired and wireless connection. Examples of the connections can include, but are not limited to, Local Area Networks (LANs), Wide Area Networks (WANs), Wireless LANs (WLANs), Wireless WANs (WWANs), and the Internet.

The data transformation module is operable to receive pre-defined data formats for the values of data fields for a specific data category. Throughout the present disclosure, pre-defined data formats relate to a standard or desired format in which the data from the data source is to be transformed into. Specifically, the pre-defined data formats for the values of data fields for the specific data category are parameters that can be used to transform the existing format of the data fetched from the data sources. In an example, the pre-defined formats of a data category, namely a patent document may comprise predefined formats for the values of data fields. In such example, a data field, namely the title may be having a value of the font to be “Time New Roman” and font size to be 20. In such example, another data field, namely the date of publishing may be having a value, such as “XX-XX-XXXX”. Optionally, the pre-defined format for the values can be received by the data transformation module via a manual input or by machine learning algorithm. Optionally, the machine learning algorithm can be trained to provide the pre-defined format for the values on the basis of the trends in the changing requirement for the pre-defined format for the values.

Optionally, the data transformation module is further operable to identify data fields for the values of the fetched data based on at least one attribute of the values, wherein the at least one attribute comprises: a number of characters, a type, a structure and presence of keywords. In an example, the fetched data form a document of a category patents may include a field that has number of characters (namely number of words) that is 150, located at the starting of the document, have a font type of “Times New Roman”, having one or more words separated by a coma and/or a semicolon, including a keyword such as “abstract”, “a method of”, “a system of”. In such example, the data transformation module, may be operable to consider the data field as with the aforesaid attribute as an abstract.

In another example, the fetched data form a document of a category research papers may include a field that has number of characters that is 200, located at first page of the document, have a font type of “Times New Roman”, have a font style of “Bold and Italics”, having one or more words separated by a coma and/or a semicolon, having a sequence of numbers, and including a keyword such as “@gmail.com”, “college”. In such example, the data transformation module, may be operable to consider the data field as with the aforesaid attribute as contact information of researcher(s).

In yet another example, the fetched data form a document of a category patents may include a field that has number of characters that is 500, located after 4 fields of the document, have a font type of “Times New Roman”, having one or more words separated by a coma and/or a semicolon, and including a keyword such as “summarizes”, “advantages”, “overcomes”. In such example, the data transformation module, may be operable to consider the data field as with the aforesaid attribute as summary.

In yet another example, the fetched data form a document of a category business plans may include a field that has number of characters that is 150, have a font type of “Times New Roman”, having one or more words separated by a coma and/or a semicolon, and including a keyword such as “different”, “problem”, “solution”, “competition”. In such example, the data transformation module, may be operable to consider the data field as with the aforesaid attribute as existing competitors.

Optionally, the data transformation module may receive the fetched data from the data fetching module, wherein the fetched data including one or more data fields is fetched by the fetching module from an unknown source thereby not being classified into any data category. The data transformation module can classify this received fetched data into a data category based on the at least one attribute of the values in one or more data fields, wherein the at least one attribute comprises: a number of characters, a type, a structure and presence of keywords.

The data transformation module is operable to compare data formats of values of data fields of the fetched data with received pre-defined data formats for the values. Specifically, the set of routines of the data transformation module is configured to compare data formats of values of data fields of the fetched data with received pre-defined data formats for the values. The set of routines is responsible for executing instructions or sub-set of instructions from the instruction set that performs the comparison. The instructions or a sub-set of instructions analyses the data formats of values of data fields of the fetched data with respect to the pre-defined data formats for the values. Optionally, the comparison between the data formats of the fetched data and the pre-defined data format is done by comparing the values in the data fields of the fetched data with the pre-defined data format. In an example, in the category patents the data field abstract may have a certain data value, such the 153. In such example, the pre-defined data formats may include that the category patents the data field abstract may have a certain data value, such the 150. It will be appreciated that the data value here is the number of words in the text segregated in the data field abstract. In such example, the set of routines of the data transformation module is configured to compare the data field abstract having the value 153 with the data field abstract having the value 150.

The data transformation module is operable to determine the deviation between the data format of at least one value and the corresponding pre-defined data format for the at least one value. Throughout the present disclosure, deviation relates to the difference between data formats of data in the data field with the corresponding pre-defined data formats of data in the data field on the basis of the comparison made between them. Optionally, the deviation between the data format of at least one value and the corresponding pre-defined data format for the at least one value can be determined by comparing the values of data fields of the fetched data with received pre-defined data formats for the values. Furthermore, the set of routines of the data transformation module is configured to determine the deviation between the data format of at least one value and the corresponding pre-defined data format for the at least one value. Optionally, the set of routines of the data transformation module determines the deviation by comparing the values of the at least one attribute namely number of characters, type, structure and presence of keywords of the data field. In an example, the pre-defined data format for the abstract data field can have values in font size: 10, font color: red, and number of text less than 200 words, and the fetched data may have a format having values in font size: 12, font color: black, and number of text in 210 words. In such example, the set of routines of the data transformation module determines the deviation. In such example, the deviation describes that font sized is deviated by 2 units, font color is deviated, number of characters in the text is deviated by 10 characters.

The data transformation module is operable to transform the data format of the at least one value to the corresponding pre-defined data format, if the deviation is determined. The transforming of the data format refers to altering the at least one value associated to the data format to a specific value that is equivalent to the data values of the at least one value of the pre-defined data format. Specifically, the set of routines of the data transformation module is configured to transform the data format of the at least one value to the corresponding pre-defined data format, if the deviation is determined. In an example, the pre-defined data format for the abstract data field can have values in font size: 10, font color: red, and number of text less than 200 words, and the fetched data may have a format having values in font size: 12, font color: black, and number of text in 210 words. In such example, the set of routines of the data transformation module may determine the font size to be deviated by 2 units, font color is deviated to red from black, number of characters in the text is deviated by 10 characters, in the at least one value of the data format of the fetched data with respect to the at least one value of the corresponding pre-defined data format of the data field. Furthermore, in such example, the set of routines may be configured to transform the values of the fetched data to have the values in font size 10, font color to be red, and number of text to be less than 200 words.

Optionally, in an event wherein the deviation is determined, the set of routines of the data transformation module can directly transform the fetched data, wherein the fetched data is in editable format. It will be appreciated that editable format refers to the format of the fetched data in which the fetched data can be changed on the basis of the determined deviation. In an example, the fetched data in editable format can be in Microsoft word format, Microsoft excel format and the like. Optionally, in the event wherein the deviation is determined and the fetched data is in a non-editable format, the set of routines of the data transformation module is configured to convert the non-editable format of the fetched data into an editable format and subsequently transform the fetched data. It will be appreciated that the non-editable format refers to a format of the fetched data in which the fetched data cannot be edited on the basis of the determined deviation. In a example, the fetched data may be in PDF format, in such event, the set of routines is configured to transform the fetched data into editable format such as Microsoft word format, Microsoft excel format and the like, and thereafter transform the values in the data fields. Optionally, the event wherein the deviation is determined and the fetched data is in unformatted, the set of routines of the data transformation module is configured to convert the unformatted data into a data format that is similar to the pre-defined data format. In an example, the fetched data is readings of a sensor, in such event, the set of routines is configured to transform the data into data format that corresponds to the pre-defined data format.

Optionally, the data transformation module is implemented using a machine-learning algorithm. The machine-learning algorithm can be trained to transform the fetched data from the data source according to the pre-defined data format based on the determined deviation between the format of the fetched data and the pre-defined data format. Optionally, the machine-learning algorithm can have pre-defined instructions for directly transforming the data, the instructions comprising various parameters like steps for transforming. Optionally, the machine-learning algorithm along with manual inputs can be implemented together on data transformation module for transforming the fetched data.

The data processing arrangement comprises a data validation module. Throughout the present disclosure, data validation module relates to a combination of hardware and/or software instructions which are operable for validate data from the data received from the data transformation module. Optionally, the data validation module is a collection or a set of routines responsible for executing an instruction or a sub-set of instructions from the instruction set that is executed by the data validation arrangement, to generate a specific output from an input. Specifically, the set of routines of the data validation module executing an instruction or a sub-set of instructions is operable to validate data that is received from the data transformation module.

The data validation module is operable to receive from the data transformation module, the pre-defined data formats, and the transformed data if the deviation is determined, or the fetched data if the deviation is not determined. Specifically, the set of routines of the data transformation module is configured to provide the pre-defined data formats, and the transformed data to the data validation module in the event wherein the deviation is determined between the data format of at least one value and the corresponding pre-defined data format for the at least one value. Alternatively, the set of routines of the data transformation module is configured to provide the pre-defined data formats, and the fetched data in the event wherein deviation isn't determined between the data format of at least one value and the corresponding pre-defined data format for the at least one value.

Furthermore, the set of routines of the data validation module is operable to receive the data provided by the data transformation module. Optionally, in an environment wherein the data processing arrangement is implemented in a distributed environment, the data validation module is operable to receive the data from the data transformation module via various connections, such as wireless connection, wired connection or a combination of wired and wireless connection. Examples of the connections can include, but are not limited to, Local Area Networks (LANs), Wide Area Networks (WANs), Wireless LANs (WLANs), Wireless WANs (WWANs), and the Internet. Optionally, the data validation module receives the pre-defined format via a manual input or by machine learning algorithm. Optionally, the machine learning algorithm can be trained to provide the pre-defined format for the values on the basis of the trends in the changing requirement for the pre-defined format for the values.

The data validation module is operable to confirm if data formats of values of all data fields of a received data are same as corresponding pre-defined data formats. Specifically, the confirmation is based on the comparison between the data formats of the received data and the pre-defined data format. Furthermore, the set of routines of the data validation module is operable to compare to determine if the data formats of values of all data fields of a received data are same as corresponding pre-defined data formats. The set of routines of the data validation module is configured to implement the comparison by comparing the values in the data fields of the received data with the data fields in the pre-defined data format. In an example, research papers may be a data category having the abstract data field having certain values with font size: 10, font colour: black, and 150 words. In such example, the set of routines of the data validation module is configured to compare the values of the abstract (namely, the font size: 10, font colour: black, and 150 words) to the values (namely, font size: 10, font colour: black, and number of text is 150 words) of values associated to the data field abstract of the pre-defined format. In such example, the set of routines of the data validation module may confirm that the data formats of values of all data fields of a received data are same as corresponding pre-defined data formats.

The system further comprises a data regularisation module. Throughout the present disclosure, “data regularisation module” relates to a combination of hardware and/or software instructions which are operable to regularise data from the data source. Optionally, the data regularisation module can include a collection or a set of routines responsible for executing an instruction or a sub-set of instructions from the instruction set that is executed by the data processing arrangement, to generate a specific output from an input. Specifically, the set of routines of the data regularisation module executing an instruction or a sub-set of instructions is operable to validate data that is fetched from the data regularisation module.

The data regularisation module receives data from the data validation module having data formats of values of one or more data fields that are not same as the corresponding pre-defined data formats. Optionally, the set of routines included in the data validation module is operable to provide the data regularisation module with the data in the event wherein the set of routines of the data validation module confirm that the data formats of values of all data fields of a received data are not same as corresponding pre-defined data formats. In an example, the data received by the data validation module may include research papers as a data category having the abstract data field having certain values with font size: 12, font colour: black, and 150 words. In such example, the set of routines of the data validation module is configured to compare the values of the abstract (namely, the font size: 12, font colour: black, and 150 words) to the values (namely, font size: 10, font colour: red, and number of text less than 200 words) of associated to the data field abstract of the pre-defined format. In such example, the set of routines of the data validation module may confirm that the data formats of values of all data fields of a received data are not same as corresponding pre-defined data formats. In such example, the set of routines included in the data validation module is operable to provide the data regularisation module with the research papers data including the abstract data field having certain values with font size: 12, font colour: black, and 150 words.

Optionally, in the event wherein the data validation module and the data regularisation module are operating in separate hardware, the data regularisation module can receive the data from the data validation module by connections like wireless connection, wired connection or a combination of wired and wireless connection.

The data regularisation module determines a variance in data formats of values of the one or more data fields of the received data and the corresponding pre-defined data formats. The determination of the variation is based on the comparison between the data formats of the values of the received data and the corresponding pre-defined data format, wherein the comparison is implemented by comparing the values in the data fields of the received data with the data fields in the pre-defined data format. Optionally, the comparing of the values in the data fields of the received data is done by matching each letter of the value one at a time with the pre-defined data format. Optionally, the comparing of the values in the data fields of the received data is done by matching each word of the value one at a time with the pre-defined data format. Optionally, the comparing of the values in the data fields of the received data is done by matching whole value in a field at a time with the pre-defined data format. In an example, research papers may be a data category including the data field as abstract, having certain values with font size: 12, and font colour: black, each letter's font size and font colour is compared with font size and font colour of pre-defined data format namely, font size: 10, and font colour: red. In such example, a variance is determined describing variance in the font size to be 2 units and the variance in the font colour to be black.

Optionally, the data regularization module is further operable to generate an error log based on the variance in data formats of values of the one or more data fields of the received data and the corresponding pre-defined data formats. The error log relates to a list of errors corresponding to the variance between data formats of values of the one or more data fields of the received data and the corresponding pre-defined data formats. Optionally, the list of errors can comprise errors in an ascending order, wherein ascending order relates to a sequence of errors in which the variance that is found first is placed at top of the error list. Optionally, the list of errors can comprise errors in a descending order, wherein descending order relates to a sequence of errors in which the variance that is found first is placed at bottom of the error list. Optionally, the list of errors can comprise errors in no-order of their determination, wherein no-order relates to a sequence of errors in which the errors are placed randomly in the error list.

The data regularisation module is operable to identify a resolution for the determined variance of the received data, wherein the resolution comprises changing the data formats of values of the one or more data fields to the corresponding pre-defined data formats. Optionally, the set of routines included in the data regularisation module is operable to identify a resolution for the determined variance of the received data. Furthermore, the set of routines included in the data regularisation module is operable to change the data formats of values of the one or more data fields to the corresponding pre-defined data formats. In an example, resolution can refer to changing the font style of values in description of embodiment data field of received data format presently in font style: bold to font style: italics which is in the description of embodiment data field of pre-defined data format. In another example, resolution can also refer to classifying a value which is presently not classified under any data field in the received data format to description of embodiment data field when the number of words in the value is more than 2000 words.

Optionally, the regularisation of data relates to resolution for the determined variance of the data formats of received data from the pre-defined data formats, wherein resolution refers to changing the values in one or more data fields of received data formats according to the pre-defined data formats. In an example, resolution can refer to changing the font size of values in abstract data field of received data format presently in size 12 to font size 14 which is in the data field of pre-defined data format. In another example, resolution can also refer to classifying a value which is presently not classified under any data field in the received data format to description of embodiment data field when the number of words in the value is more than 1500 words.

Optionally, the resolution can be implemented on the received data directly when the received data is in editable format, wherein editable format refers to the format of the received data in which the received data can be changed on the basis of the determined variation. In an example, the received data in editable format can be in Microsoft word format, Microsoft excel format and the like.

In another embodiment, the resolution can be implemented on the received data when the received data is in non-editable format, wherein non-editable format refers to the format of the received data in which the received data cannot be edited on the basis of the determined variation. In such a case, the received data in the non-editable format is converted to the editable format, further the received data is changed on the basis of the determined variance. In an example, the received data in non-editable format can be portable document format (PDF). Subsequently, after the change in the received data on the basis of the determined deviation the received data can be converted back to the non-editable format.

Optionally, in the event wherein the data regularisation module is not able to identify a resolution for the determined variance of the received data, the data validation module is further operable to generate a notification comprising data formats of values of the one or more data fields not being same as the corresponding pre-defined data formats. The notification is generated corresponding to the error log that has been generated by the data regularisation module. The notification is to be addressed by the owner of data format, wherein owner refers to an entity owning the data source of the data format. The owner of the data format can edit the data formats of the values of the one or more data fields which are not same as the corresponding pre-defined data formats. Optionally, the owner can receive one notification for one dissimilar data format of values of one field. Optionally, the owner can receive one notification for the entire dissimilar data format of values of more than one field. In an example, the owner can receive one notification for dissimilar values of abstract data field. In another example, the owner can receive one notification for dissimilar values of abstract data field, summary data field and description data field. Optionally, the owner can receive one notification for all dissimilar data format of all data fields for a particular data category. In an example, the owner can receive one notification for all dissimilar data format of all data fields for patent data category. Furthermore, based on the notification corresponding to the error, the owner has to provide the resolution for the determined variance of the received data by the data validation module. The resolution comprises changing the data formats of values of the one or more data fields. In an example, the date format of received data is 28-02-12, the data regularisation module is not able to identify a resolution for the date format as date, month and year cannot be interpreted from the 28-02-12, in such a case, corresponding notification is generated and the owner provides a resolution by providing the date in better format like 28-02-2012. Optionally, the owner can receive the notification via an email, a push-notification, a message, and a call.

Optionally, the error log generated by the data regularisation module is published on the online sheet (such as a google spreadsheet), wherein the owner can provide the resolution to the determined variance of the received data. Optionally, in the event wherein, the owner has provided a resolution to the determined variance, the online sheet can be cleared for a new error log.

Optionally, the data regularisation module, based on the resolution provided by the owner, resolution is implemented on the received data directly when the received data is in editable format (such as the Microsoft word format, Microsoft excel format and the like). In another embodiment, the data regularisation module, based on the resolution provided by the owner, resolution is implemented in non-editable format (such as portable document format (PDF)). Subsequently, after the change in the received data on the basis of the determined deviation the received data can be converted back to the non-editable format. Optionally, the resolved data is transmitted to the data transformation module, by connections like wireless connection, wired connection or a combination of wired and wireless connection. Optionally, the resolution of the received data formats can be performed at the data validation module.

Optionally, the data regularisation module is implemented using a machine-learning algorithm. The machine-learning algorithm can be trained to regularise the received data according to the resolution performed on the received data previously. Optionally, the machine-learning algorithm can have pre-defined instructions for directly regularising the data, the instructions comprising various parameters like steps for regularising. Optionally, the machine-learning algorithm along with manual inputs can be implemented together on data regularisation module for regularising the received data. The data transformation module is further operable to process the resolved data along with the fetched data. Furthermore, the data transformation module can further compare the resolved data with pre-defined data formats, and subsequently, determine the deviation between the data format of received data and corresponding pre-defined data format. Further the resolved data will be sent to the data validation module by the data transformation module for confirming that the data formats of resolved data is similar to the pre-defined data format.

The data validation module is operable to identify from the received data, based on the confirmation, regularised data having data formats of values of all data fields same as the corresponding pre-defined data formats. Optionally, the set of routines of the data validation module is operable to identify the regularised data having data formats of values of all data fields same as the corresponding pre-defined data formats that are confirmed. Specifically, the regularised data refers to the data that is validated to have values that are similar to the values associated to the pre-defined data formats. In an example, research papers may be a data category having the abstract data field having certain values with font size: 10, font colour: black, and 150 words. In such example, the set of routines of the data validation module is configured to compare the values of the abstract (namely, the font size: 10, font colour: black, and 150 words) to the values (namely, font size: 10, font colour: black, and number of text is 150 words) associated to the data field abstract of the pre-defined format. In such example, the set of routines of the data validation module may confirm that the data formats of values of all data fields of a received data are same as corresponding pre-defined data formats. In such example, the set of routines of the data validation module may identify the data field abstract of the data category research paper having values with font size: 10, font colour: black, and 150 words as regularised data.

The data validation module is operable to transmit the regularised data to the data destination. Specifically, the set of routines of the data validation module can employ one or more hardware unit included in the data validation module to transmit the data destination. Optionally, the data validation module is operable to transmit the regularised data to the data destination via a data network. Throughout the present disclosure, the term “data network” relates to an arrangement of interconnected programmable and/or non-programmable components that are configured to facilitate data communication between data validation module and the data destination. Furthermore, the data network may include, but is not limited to, one or more peer-to-peer network, a hybrid peer-to-peer network, local area networks (LANs), radio access networks (RANs), metropolitan area networks (MANS), wide area networks (WANs), all or a portion of a public network such as the global computer network known as the Internet, a private network, a cellular network and any other communication system or systems at one or more locations. Additionally, the data network includes wired or wireless communication that can be carried out via any number of known protocols, including, but not limited to, Internet Protocol (IP), Wireless Access Protocol (WAP), Frame Relay, or Asynchronous Transfer Mode (ATM).

The system comprises database arrangement for implementing the data destination. Throughout the present disclosure, the term “database arrangement” as used herein relates to an organized body of digital information regardless of the manner in which the data or the organized body thereof is represented. Optionally, the database may be hardware, software, firmware and/or any combination thereof. For example, the organized body of related data may be in the form of a table, a map, a grid, a packet, a datagram, a file, a document, a list or in any other form. The database arrangement includes any data storage software and systems, such as, for example, a relational database like IBM DB2 and Oracle 9. Furthermore, the database management refers to the software program for creating and managing one or more databases. Optionally, the database arrangement may be operable to support relational operations, regardless of whether it enforces strict adherence to the relational model, as understood by those of ordinary skill in the art. The database arrangement being communicatively coupled to the data processing arrangement. Specifically, the database arrangement is operable to receive the regularized data transmitted by the data validation module. Optionally, the database arrangement is operable to establish a data connection to transmit regularized data provided by the data validation module of the data processing arrangement. The database arrangement is operable to store the received regularised data. Specifically, the database arrangement populated by data elements, namely regularized data. The database arrangement is operable to store regularised data in various table, a map, a grid, a packet, a datagram, a file and the like.

Optionally, the database destination can store the received regularised data of single data category at a single database. Optionally, the database destination can store the received regularised data of multiple data category at a single database. In an example, patent data category can be stored in a first database, research paper data category can be stored in a second database, business plan data category can be stored in a third database, medical report data category can be stored in a fourth database, and sales report data category can be stored in a fifth database. In another example, the research paper data category, sales report data category, business plan data category, and medical report data category can all be stored in a single database.

Optionally, the system further comprises a database driver module, wherein the database driver module allows retrieval of the regularised data stored in the database arrangement. The database driver module relates to a combination of hardware and/or software instructions which are operable to retrieve regularised data which is stored in the database arrangement. Optionally, the database driver module can retrieve regularised data relating only to single data category. Optionally, the database driver module can retrieve regularised data relating to all data category. Optionally, the database driver module can retrieve regularised data on the basis of keywords, data fields, and data category. In an example, database driver module can retrieve regularised data related to abstract data field in patent data category.

Optionally, the system can simultaneously regularise, in operation, data corresponding to more than one data category of the plurality of data categories. In an example, patent data category, research paper data category, sales report data category, business plan data category, and medical report data category can all be regularised simultaneously. Optionally, when data from the similar data source is being fetched continuously and similar transformation are being performed, the machine learning algorithm can use the data source as a track to automatically fetch the data from the data source and also automatically perform transformation without comparison of received data with pre-defined data formats and without determining the deviation between the received data with pre-defined data formats.

The present disclosure also relates to the method as described above. Various embodiments and variants disclosed above apply mutatis mutandis to the method.

Optionally, the method for regularising data between a data source and a data destination, the data corresponding to a given data category of a plurality of data categories, wherein the given data category includes with specific data fields, wherein the method comprises:

fetching from the data source, a data including one or more data fields having values in corresponding data formats;

receiving pre-defined data formats for the values of data fields for a specific data category;

comparing data formats of values of data fields of the fetched data with pre-defined data formats for the values;

determining, based on the comparison, a deviation between a data format of at least one value and a corresponding pre-defined data format for the at least one value;

transforming the data format of the at least one value to the corresponding pre-defined data format, if the deviation is determined;

confirming if data formats of values of all data fields of a received data are same as corresponding pre-defined data formats;

identifying from the received data, based on the confirmation, regularised data having data formats of values of all data fields same as the corresponding pre-defined data formats; and storing the regularised data at the data destination.

Optionally, the method further comprises generating an error log for the received data when data formats of values of one or more data fields are not same as the corresponding pre-defined data formats.

Optionally, the method further comprises:
determining a variance in data formats of values of the one or more data fields of the received data and the corresponding pre-defined data formats;
identifying a resolution for the determined variance of the received data, wherein the resolution comprises changing the data formats of values of the one or more data fields to the corresponding pre-defined data formats; and
processing the resolved data along with the fetched data.

Optionally, the method employs at least one machine-learning algorithm.

Optionally, the method is implemented as a web-crawler.

Optionally, the method further comprises identifying data fields for the values of the fetched data based on at least one attribute of the values, wherein the at least one attribute comprises: a number of characters, a type, a structure and presence of keywords.

Optionally, the method further comprises generating a notification comprising data formats of values of the one or more data fields not being same as the corresponding pre-defined data formats.

In an aspect, the present disclosure provides a computer readable medium containing program instruction for execution on a computer system, which when executed by a computer, cause the computer to perform method steps for regularizing data between a data source and a data destination, the data corresponding to a given data category of a plurality of data categories, wherein the given data category includes with specific data fields, the method comprising the steps of:

fetching from the data source, a data including one or more data fields having values in corresponding data formats;

receiving pre-defined data formats for the values of data fields for a specific data category;

comparing data formats of values of data fields of the fetched data with pre-defined data formats for the values;

determining, based on the comparison, a deviation between a data format of at least one value and a corresponding pre-defined data format for the at least one value;

transforming the data format of the at least one value to the corresponding pre-defined data format, if the deviation is determined;

confirming if data formats of values of all data fields of a received data are same as corresponding pre-defined data formats;

identifying from the received data, based on the confirmation, regularized data having data formats of values of all data fields same as the corresponding pre-defined data formats; and

storing the regularized data at the data destination.

### DETAILED DESCRIPTION OF THE DRAWINGS

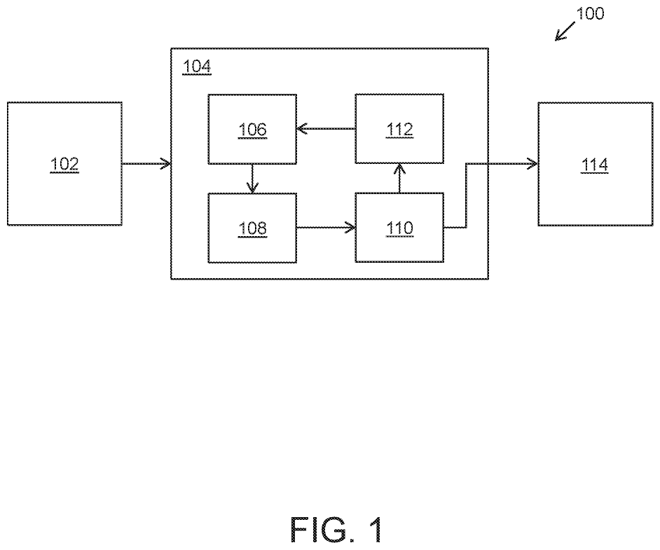

Referring to FIG. 1, there is provided a block diagram of a system 100 for regularizing data between a data source and a data destination, in accordance with an embodiment of the present disclosure. The system 100 comprises a data source 102, a data processing arrangement 104 and a data destination 114. Furthermore, as shown, the data processing arrangement 104 includes a data fetching module 106, a data transformation module 108, a data validation module 110, data regularization module 112. Optionally, the data source 102 can be implemented using at least one database and the data destination 114 is implemented using a database arrangement.

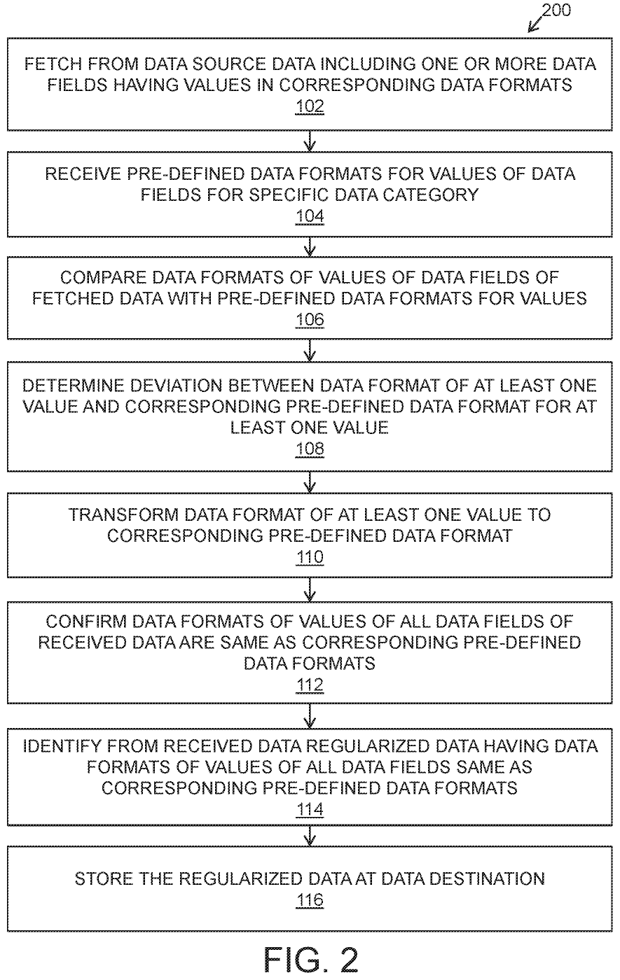

Referring to FIG. 2, there are illustrated therein steps of a method 200 for (of) regularizing data between a data source and a data destination, in accordance with an embodiment of the present disclosure. At a step 202, a data including one or more data fields having values in corresponding data formats is fetched from the data source. At a step 204, pre-defined data formats are received for the values of data fields for a specific data category. At a step 206, data formats of values of data fields of the fetched data with pre-defined data formats for the values is compared. At a step 208, a deviation between a data format of at least one value and a corresponding pre-defined data format for the at least one value is determined based on the comparison. At a step 210, the data format of the at least one value to the corresponding pre-defined data format is transformed, if the deviation is determined. At a step 212, data formats of values of all data fields of a received data is confirmed if the data formats are same as corresponding pre-defined data formats. At a step 214, regularized data is identified from the received data based on the confirmation, having data formats of values of all data fields same as the corresponding pre-defined data formats. At a step 216, the regularized data is stored at the data destination.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

What is claimed is:

1. A system for regularizing data between a data source and a data destination, the data corresponding to a given data category of a plurality of data categories, wherein the given data category includes specific data fields, wherein the system comprises:
a data processing arrangement comprising:
a data fetching module operable to fetch data from the data source, wherein the fetched data includes one or more data fields having values in corresponding data formats;
a data transformation module operable to receive the fetched data from the data fetching module, wherein the data transformation module is operable to:
receive pre-defined data formats for the values of data fields for a specific data category;
compare data formats of values of data fields of the fetched data with received pre-defined data formats for the values;
determine, based on the comparison, a deviation between a data format of at least one value and a corresponding pre-defined data format for the at least one value; and
transform the data format of the at least one value to the corresponding pre-defined data format, if the deviation is determined;
a data validation module operable to:
receive from the data transformation module, the pre-defined data formats, and the transformed data if the deviation is determined, or the fetched data if the deviation is not determined;
confirm if data formats of values of all data fields of a received data are same as corresponding pre-defined data formats;
identify from the received data, based on the confirmation, regularized data having data formats of values of all data fields same as the corresponding pre-defined data formats;
transmit the regularized data to the data destination; and
a database arrangement for implementing the data destination, the database arrangement being communicatively coupled to the data processing arrangement, wherein the database arrangement is operable to store the received regularized data.

2. The system of claim 1, wherein the data validation module is further operable to generate an error log for the received data when data formats of values of one or more data fields are not same as the corresponding pre-defined data formats.

3. The system of claim 2, wherein the system further comprises a data regularization module, wherein the data regularization module is operable to:
receive data from the data validation module having data formats of values of one or more data fields that are not same as the corresponding pre-defined data formats;
determine a variance in data formats of values of the one or more data fields of the received data and the corresponding pre-defined data formats;
identify a resolution for the determined variance of the received data, wherein the resolution comprises changing the data formats of values of the one or more data fields to the corresponding pre-defined data formats; and
transmit the resolved data to the data transformation module,
wherein the data transformation module is further operable to process the resolved data along with the fetched data.

4. The system of claim 1, wherein the data source is implemented using at least one database.

5. The system of claim 1, wherein the data processing arrangement is implemented within a server arrangement.

6. The system of claim 1, wherein at least one of: the data fetching module, the data transformation module, the data validation module, and the data regularization module, is implemented using a machine-learning algorithm.

7. The system of claim 1, wherein the data fetching module is implemented as a web-crawler.

8. The system of claim 1, wherein the data transformation module is further operable to identify data fields for the values of the fetched data based on at least one attribute of the values, wherein the at least one attribute comprises: a number of characters, a type, a structure and presence of keywords.

9. The system of claim 1, wherein the data validation module is further operable to generate a notification comprising data formats of values of the one or more data fields not being same as the corresponding pre-defined data formats.

10. The system of claim 1, wherein the system further comprises a database driver module, wherein the database driver module allows retrieval of the regularized data stored in the database arrangement.

11. The system of claim 1, wherein the system simultaneously regularizes, in operation, data corresponding to more than one data category of the plurality of data categories.

12. A method for regularizing data between a data source and a data destination, the data corresponding to a given data category of a plurality of data categories, wherein the given data category includes with specific data fields, wherein the method comprises:
fetching from the data source, a data including one or more data fields having values in corresponding data formats;
receiving pre-defined data formats for the values of data fields for a specific data category;
comparing data formats of values of data fields of the fetched data with pre-defined data formats for the values;
determining, based on the comparison, a deviation between a data format of at least one value and a corresponding pre-defined data format for the at least one value;
transforming the data format of the at least one value to the corresponding pre-defined data format, if the deviation is determined;
confirming if data formats of values of all data fields of a received data are same as corresponding pre-defined data formats;
identifying from the received data, based on the confirmation, regularized data having data formats of values of all data fields same as the corresponding pre-defined data formats; and
storing the regularized data at the data destination.

13. The method of claim 12, wherein the method further comprises generating an error log for the received data when data formats of values of one or more data fields are not same as the corresponding pre-defined data formats.

14. The method of claim 13, wherein the method further comprises:
determining a variance in data formats of values of the one or more data fields of the received data and the corresponding pre-defined data formats;
identifying a resolution for the determined variance of the received data, wherein the resolution comprises changing the data formats of values of the one or more data fields to the corresponding pre-defined data formats; and
processing the resolved data along with the fetched data.

15. The method of claim 14, wherein the method employs at least one machine-learning algorithm.

16. The method of claim 12, wherein the method is implemented as a web-crawler.

17. The method of claim 12, wherein the method further comprises identifying data fields for the values of the fetched data based on at least one attribute of the values, wherein the at least one attribute comprises: a number of characters, a type, a structure and presence of keywords.

18. The method of claim 12, wherein the method further comprises generating a notification comprising data formats of values of the one or more data fields not being same as the corresponding pre-defined data formats.

19. A computer readable medium containing program instructions for execution on a computer system, which when executed by a computer, cause the computer to perform method steps for regularizing data between a data source and a data destination, the data corresponding to a given data category of a plurality of data categories, wherein the given data category includes with specific data fields, the method comprising the steps of:
fetching from the data source, a data including one or more data fields having values in corresponding data formats;
receiving pre-defined data formats for the values of data fields for a specific data category;
comparing data formats of values of data fields of the fetched data with pre-defined data formats for the values;
determining, based on the comparison, a deviation between a data format of at least one value and a corresponding pre-defined data format for the at least one value;
transforming the data format of the at least one value to the corresponding pre-defined data format, if the deviation is determined;
confirming if data formats of values of all data fields of a received data are same as corresponding pre-defined data formats;
identifying from the received data, based on the confirmation, regularized data having data formats of values of all data fields same as the corresponding pre-defined data formats; and
storing the regularized data at the data destination.
